(19) United States
(12) Patent Application Publication
(10) Pub. No.: US 2007/0237622 A1
(43) Pub. Date: Oct. 11, 2007

(54) Palletizing apparatus

(75) Inventor: Thomas B. Domenz, Schaumburg, IL (US)

Correspondence Address: WOOD, PHILLIPS, KATZ, CLARK & MORTIMER, 500 W. MADISON STREET, SUITE 3800, CHICAGO, IL, 60661, US

(73) Assignee: Reichel & Drews, Inc.

(21) Appl. No.: 11/400,115

(22) Filed: Apr. 7, 2006

(51) Int. Cl. B65G 57/22

(52) U.S. Cl. 414/791.6

(57) ABSTRACT

A palletizing apparatus is configured to assemble groups of articles, and successively transfer the groups onto an associated pallet. The apparatus includes lugging and transfer sections where the groups of articles are assembled, and thereafter transferred to a vertically adjustable shuttle conveyor apparatus. The shuttle conveyor apparatus includes a horizontally reciprocable shuttle conveyor, which can move from a first, retracted position, to a second, extended position. During retraction of the shuttle conveyor from its second position to its first position, the conveyor is operated so that each group of articles is transferred therefrom onto the associated pallet. Features of the present apparatus facilitate its efficient and consistent operation, while avoiding excessive wear of the apparatus.

### TECHNICAL FIELD

The present invention relates generally to an apparatus for successively positioning groups of articles in layers on an associated pallet, and more particularly to a palletizing apparatus configured to facilitate efficient, accurate positioning of groups of relatively heavy articles, which may comprise bundles of asphalt roofing shingles, while avoiding damage to the articles themselves, and excessive wear to the apparatus.

### BACKGROUND OF THE INVENTION

Attendant to shipment and storage of various articles, it is common for such articles to be arranged in layers on an associated pallet to facilitate handling of the articles by a forklift or other piece of equipment. While a variety of different palletizing apparatus are known, heretofore, handling and palletizing of relatively heavy articles, such as bundles of asphalt roofing shingles, has required use of specialized palletizing equipment.

In one known palletizing apparatus for handling bundles of roofing shingles, the apparatus has includes a so-called lugging section, wherein groups of articles are assembled, and thereafter moved to an associated so-called transfer section where the articles are temporarily held before being further moved for stacking upon an associated pallet. In this previous device, the transfer section included an arrangement of continuously running transfer conveyor belts and retractable stop elements, whereby each group of articles was advanced onto the transfer section, and held by the stop elements against further movement by the continuously running conveyor belts. Retraction of the stop elements permitted each group of articles to thereafter be advanced off of the transfer section.

While this previous arrangement effected the desired intermittent advancement of each group of articles, the apparatus was susceptible to damage attendant to impact loading of the stop elements as the articles of each group are advanced into position against the stop elements. Additionally, the continuously running belts could undesirably mar or damage the articles or their packaging as the articles are held in position against the retractable stop elements.

In this previous apparatus, each group of articles to be stacked on the associated pallet was transferred to a so-called shuttle conveyor, mounted on a scissors linkage for vertically adjustable movement. The shuttle conveyor could be horizontally reciprocated, into a generally cantilevered position, and thereafter retracted and operated such that a group of articles positioned thereon would be moved off of the shuttle conveyor onto the associated pallet. However, in this previous arrangement, the cantilevered portion of the shuttle conveyor was mounted in fixed relationship to the conveyor support frame, and thus could undesirably damage articles on the pallet, or damage the apparatus itself, if the shuttle conveyor was inadvertently lowered in its extended, cantilevered orientation.

Additionally, the shuttle conveyor of this previous apparatus included a “bumper” fixed to the conveyor support frame, which could be moved into engagement with a previously-stacked group of articles, as the shuttle conveyor was extended to its cantilevered orientation. However, this bumper element could not be moved independently of the shuttle conveyor, detracting from its efficient operation, since the previously-stacked group of articles might be insufficiently moved for proper “squaring” on the pallet, or moved beyond the desired “squared” orientation. Excessive engagement of the bumper with the stacked group of articles could not only cause undesired damage to the articles, but could also create undesirable impact loads in the shuttle conveyor apparatus.

In this previous palletizing device, each group of articles was moved from the transfer section to the associated shuttle conveyor by a bridge-like adjustable height conveyor, pivotally connected to the vertically movable shuttle conveyor. The infeed end of this adjustable height conveyor was carried directly by the frame of the conveyor at the transfer section, with the movement of the adjustable height conveyor relative to the transfer conveyor (attendant to vertical movement of the shuttle conveyor), accommodated by the mounting of a conveyor belt tail shaft of the adjustable height conveyor in pillow block bearings, which in turn were mounted on brass slide plates carried by the frame of transfer conveyor. As the shuttle conveyor was raised and lowered, these slides would move back and forth as the relative distance between the entry of the shuttle conveyor and the exit of the transfer conveyor changed. This sliding action was found to be subject to significant wear in the previous apparatus.

The present invention contemplates an improved palletizing apparatus which specifically addresses the deficiencies in previously known arrangements, and thus facilitates accurate and efficient palletizing of articles, including relatively heavy articles such as bundled stacks of asphalt roofing shingles.

### SUMMARY OF THE INVENTION

The present invention is directed to a palletizing apparatus which comprises a system of selectively operable conveyors which act in cooperation with each other to successively transfer groups of articles onto an associated shipping pallet, with each group of articles generally corresponding to one layer on the associated pallet. The apparatus includes a vertically adjustable shuttle conveyor from which each group of articles is transferred onto the associated pallet, after the shuttle conveyor is appropriately vertically positioned so that each group of articles can be stacked upon a previously placed group of articles. Features of the present palletizing apparatus particularly facilitate use with relatively heavy articles, such as bundled stacks of asphalt roofing shingles, but it will be recognized that an apparatus embodying the principles disclosed herein can be readily configured and operated for handling and palletizing a wide variety of different articles.

In accordance with the illustrated embodiment, the conveyor system of the present palletizing apparatus comprises a lugging conveyor for receiving groups of articles to be palletized, and a transfer conveyor positioned adjacent to and downstream of the lugging conveyor. The transfer conveyor intermittently receives the group of articles to be palletized from the lugging conveyor as the conveyors are operated in synchronization with each other.

The present apparatus further includes a shuttle conveyor apparatus positioned downstream of the transfer conveyor for intermittently receiving the groups of articles therefrom. The shuttle conveyor apparatus includes a vertically adjustable frame, preferably comprising a fluid-actuated scissors linkage, and a shuttle conveyor mounted on the vertically adjustable frame. Notably, the shuttle conveyor is mounted for reciprocable movement with respect to the frame, whereby the conveyor can be moved between a first, retracted position, and a second, extended position, wherein a portion of the shuttle conveyor is positioned in generally cantilevered fashion above an associated pallet onto which the groups of articles are to be stacked.

By this arrangement, each one of the groups of articles can be received on the shuttle conveyor in the first, retracted position thereof. After the shuttle conveyor is first moved from its retracted position to its extended position, the articles are moved off of the shuttle conveyor, and onto the associated pallet, with the articles transferred as the shuttle conveyor is operated and simultaneously moved from its second, extended position, back to its first, retracted position.

To facilitate “squaring” of each group of articles on the associated pallet, the present apparatus includes a layer pusher mounted on the vertically adjustable frame of the shuttle conveyor apparatus for engaging and pushing one of the groups of articles after movement of the articles onto the pallet from the shuttle conveyor. Notably, the layer pusher is movable independently of the reciprocable movement of the shuttle conveyor by mounting of the layer pusher on the vertically adjustable frame upon which the shuttle conveyor is reciprocably mounted. The present apparatus preferably includes a pair of pneumatically operated fluid cylinders to effect movement of the layer pusher so that the pushing force can be adjusted, depending upon the size of the article, its weight, packaging material, etc., to push with as much or as little force as may be required, thus effecting layer “squaring” in a manner which promotes product integrity, while avoiding any shock loading to the drive system which reciprocates the shuttle conveyor.

In accordance with the present invention, the shuttle conveyor includes articulable upstream and downstream conveyor sections, with each group of articles first received on the upstream section from the transfer conveyor of the apparatus, and thereafter conveyed by the downstream section as each group is moved off of the shuttle conveyor and onto the associated pallet. Notably, the downstream section of the shuttle conveyor is mounted for pivotal movement relative to the upstream section about a horizontal pivot axis. This downstream section of the shuttle conveyor, sometimes referred to as the nose section, thus is desirably provided with a “flip-up” feature. By this arrangement, any inadvertent contact between the shuttle conveyor, when in its extended position, and the articles previously stacked on the pallet, minimizes any damage to the articles and the shuttle conveyor itself, as the nose or downstream section of the shuttle conveyor is permitted to pivot upwardly if such contact should occur.

To facilitate movement of groups of articles from the transfer conveyor onto the shuttle conveyor, the shuttle conveyor apparatus includes an adjustable height conveyor extending between the transfer conveyor and the shuttle conveyor. The adjustable height conveyor includes a first, infeed end mounted for pivotal movement relative to the transfer conveyor, and a second, output end mounted for pivotal movement on the vertically adjustable frame of the shuttle conveyor apparatus. Notably, the adjustable height conveyor includes a floor-mounted support frame for pivotally supporting and bearing the load of the first end of the adjustable height conveyor, independently of the associated transfer conveyor. In order to accommodate vertical pivotal movement of the adjustable height conveyor, attendant to vertical movement of the vertically adjustable frame, the floor-mounted support frame for the adjustable height conveyor is pivotal about a horizontal pivot axis, which in the illustrated embodiment is positioned just above the floor upon which the support frame is mounted. By this arrangement, a portion of the load carried by the adjustable height conveyor is carried by the floor-mounted support frame, thus reducing the load to which the scissors linkage mechanism of the shuttle conveyor apparatus is subjected, while isolating the transfer conveyor, and its frame, from any loads carried by the adjustable height conveyor.

Efficient handling of articles is further facilitated by providing the transfer conveyor of the present palletizing apparatus with a selectively operable servo drive, whereby the transfer layer can be started and stopped for intermittently receiving and advancing each group of articles carried by the transfer conveyor. As will be appreciated, this desirably avoids impact loading of mechanical stop elements or the like, and desirably avoids damage to the articles, or their packaging, which can occur in arrangements where the articles are stopped against a mechanical stop element, but an associated conveyor belt continues to run.

Other features and advantages of the present invention will become readily apparent from the following detailed description, the accompanying drawings, and the appended claims.

### BRIEF DESCRIPTION OF THE DRAWINGS

FIG. 1 is a diagrammatic, side elevational view of a palletizing apparatus embodying the principles of the present invention;

FIG. 2 is a diagrammatic, top plan view of the palletizing apparatus illustrated in FIG. 1;

FIG. 3 is a diagrammatic, top plan view of lugging and transfer sections of the present apparatus;

FIG. 4 is a diagrammatic, side elevational view of the lugging and transfer section shown in FIG. 3;

FIG. 5 is a diagrammatic, side elevational view of an adjustable height conveyor or the present apparatus;

FIG. 6 is a diagrammatic, side elevational view of a shuttle conveyor apparatus of the present invention; and

FIG. 7 is a further diagrammatic, side elevational view of the shuttle conveyor apparatus of the present invention.

### DETAILED DESCRIPTION

While the present invention is susceptible to embodiment in various forms, there is shown in the drawings, and will hereinafter be described, presently preferred embodiments, with the understanding that the present disclosure is to be considered as an exemplification of the invention, and is not intended to limit the invention to the specific embodiment illustrated.

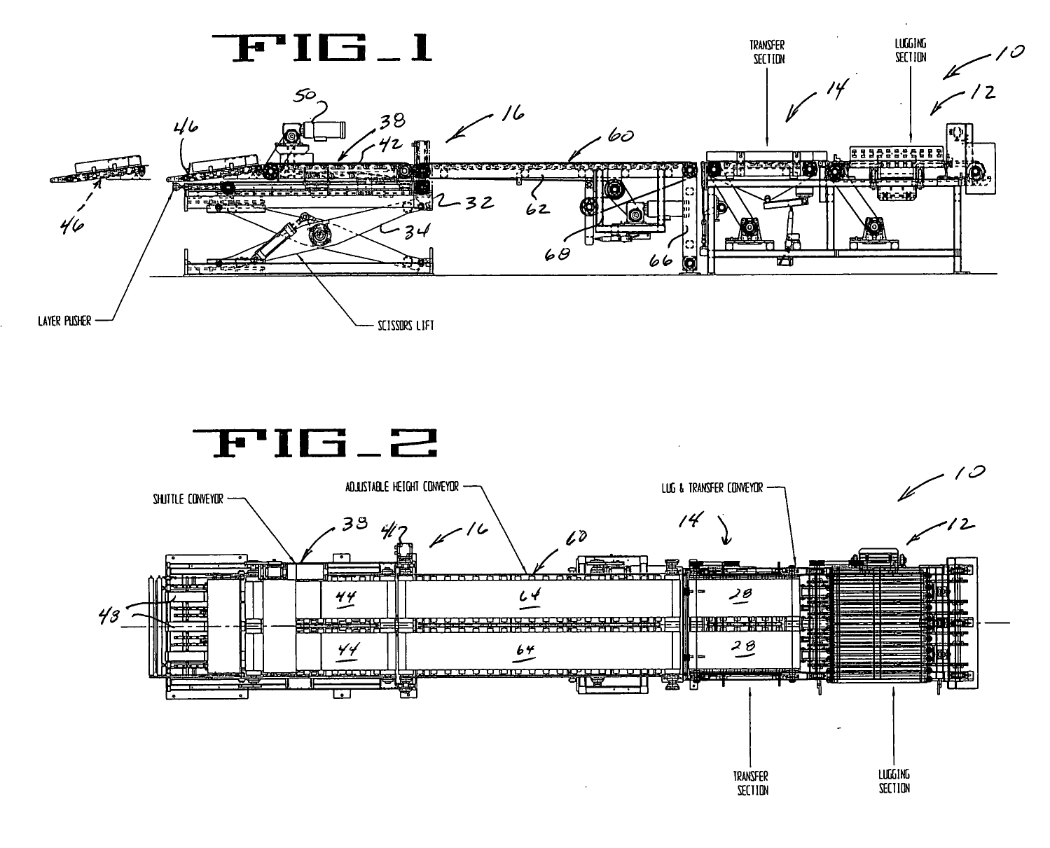

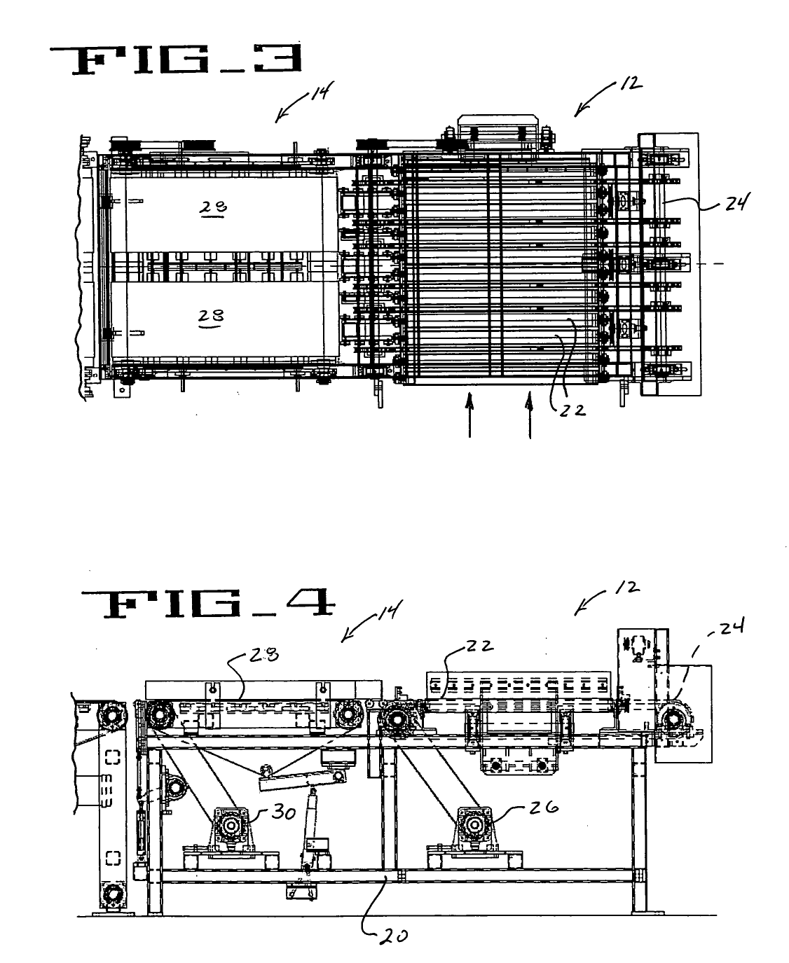

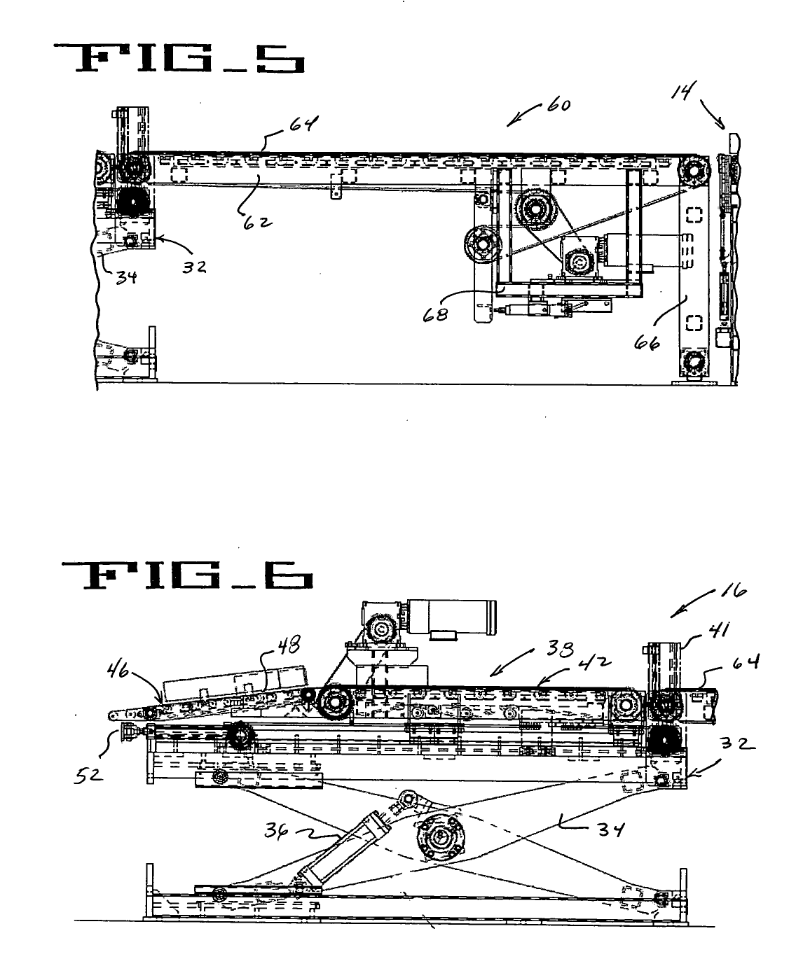

With reference now to FIGS. 1 and 2, therein is illustrated a palletizing apparatus 10 embodying the principles of the present invention. As will be further described, the apparatus 10 comprises a system of cooperating conveyor devices which act together to facilitate assembly of groups of articles for subsequent transfer and placement upon an associated shipping pallet, with each group of articles stacked upon the previous group on the pallet. While the present invention is particularly suited for handling and palletizing relatively heavy articles, such as bundled stacks of asphalt roofing shingles, it will be understood that an apparatus embodying the principles disclosed herein can be configured and operated for handling and palletizing a wide variety of different articles.

As will be further described, the system of conveyors of the present palletizing apparatus includes a conveyor arrangement provided in a lugging section 12, which is servo-operated to act in concert with a servo-operated conveyor arrangement in an immediately downstream transfer section 14. Groups of articles to be stacked on the associated pallet are assembled at the lugging section 12, with the groups of articles intermittently advanced from the lugging section to the transfer section 14. Each group of articles may be temporarily held at the transfer section 14, and thereafter advanced onto a shuttle conveyor apparatus 16, which can be selectively vertically positioned so that each group of articles is transferred from the shuttle conveyor apparatus onto an associated pallet.

The lugging section 12 of the apparatus 10 will first be described. As illustrated, this section of the apparatus includes a mounting frame 20 upon which are mounted a series of parallel rollers 22 which form a conveying surface upon which articles to be stacked on the associated pallet are assembled into the desired group or array. It is presently preferred that each group or array of articles ultimately is positioned as a single layer of articles on the associated pallet.

As will be observed, the rollers 22 of the lugging section are rotatable about respective axes which extend generally in the direction of travel of the groups of articles as they are conveyed by the palletizing apparatus 10. Thus, the articles are positioned on the lugging section as they are directed thereto from an associated infeed conveyor (not shown) with the articles being assembled in the desired group generally as they are received on the rollers 22.

After the desired group of articles has been received on the lugging section, lugging conveyor 24, comprising a plurality of upstanding lugs which project upwardly through and between the rollers 22, are operated so that the group of articles is slid off of the rollers 22 in a direction parallel to the axes of rotation of the rollers. Thus, each article is received on the lugging section by rolling movement of the rollers 22, with the assembled group of articles thereafter slid off of the rollers, in a direction perpendicular to the direction on which they were received in the lugging section, by operation of lugging conveyor 24. Operation of lugging conveyor 24 is effected by a suitable servo drive 26, which is operated in concert with a conveyor arrangement in transfer section 14, as will now be described.

In the illustrated embodiment, transfer section 14 is also provided on mounting frame 20, and includes a transfer conveyor which, in the illustrated embodiment, includes a pair of generally parallel transfer conveyor belts 28 operated by a servo drive 30. Servo drive 30 is operated in conjunction with conveyor drive 26 of the lugging section 14, so that the grouped articles are received at the transfer section and can be held in position thereat, by starting and stopping the transfer conveyor belts 28. The programmable servo drive arrangement allows the conveyor belts 28 to be precisely started and stopped, desirably eliminating the need for any mechanical stop element or the like, avoiding any damage to the articles which can occur attendant to impact with such a stop element. Because the conveyor belts 28 are intermittently started and stopped, there is no relative movement between the conveyor belts and the associated articles, thereby desirably minimizing any damage to the articles, and particularly any damage to their packaging. In the illustrated embodiment wherein the conveyor belts 28 are configured for handling groups of bundled asphalt shingles, the relatively wide conveyor belts 28 support approximately 90% of the bundle surface area, thus desirably providing protection to both the product and the packaging.

Each group of articles is advanced from the transfer section 14 onto the shuttle conveyor apparatus 16, which will not be described.

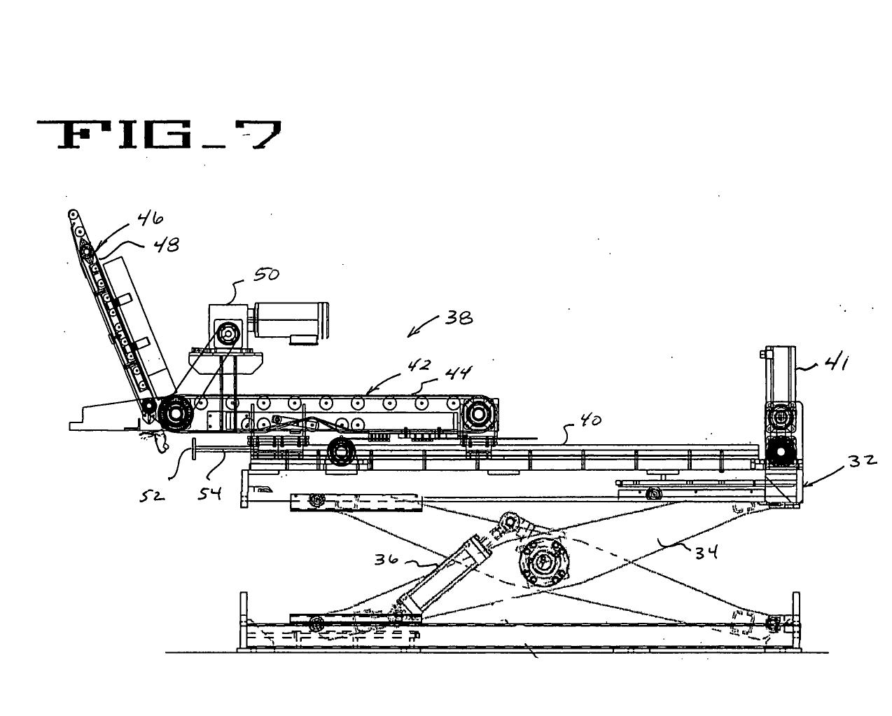

The shuttle conveyor apparatus 16 includes a vertically adjustable frame 32 including a scissors linkage 34 operated by a suitable fluid-actuated cylinder 36, preferably a hydraulically-actuated cylinder. The shuttle conveyor apparatus 16 further includes an articulable shuttle conveyor 38 mounted on the vertically adjustable frame 32 for reciprocable movement with respect thereto. In this regard, the shuttle conveyor 38 is movable between a first, retracted position, shown in FIG. 6, and a second, extended position, shown in partial phantom view in FIG. 1 and FIG. 7, where the shuttle conveyor is disposed in generally cantilevered relationship to the vertically adjustable frame 32. The frame 32 includes suitable linear guides 40 upon which the shuttle conveyor 38 is reciprocably movable, with servo drive 41, carried by frame 32, provided for selectively advancing and retracting the shuttle conveyor.

Notably, the shuttle conveyor 38 includes cooperating upstream and downstream sections, with the downstream section being articulable by mounting for pivotal movement relative to the upstream section about a horizontal pivot axis. Upstream section 42, including upstream belts 44, is generally horizontally oriented, and remains in this orientation attendant to vertical adjustment of frame 32, and attendant to reciprocable movement of the shuttle conveyor 38. Downstream section 46, including a plurality of laterally spaced conveyor belts 48, is preferably disposed in angularly downwardly inclined relationship to the conveying surface of upstream section 42, thus facilitating transfer of each group of articles from the shuttle conveyor onto the associated pallet as the shuttle conveyor is reciprocably moved from its second, extended condition (shown in phantom line in FIG. 1) to its first, retracted position. During operation in this manner, the conveyor belts of the shuttle conveyor are operated in synchronization with the reciprocation of the shuttle conveyor relative to frame 32, so that each group of articles is accurately transferred from the shuttle conveyor onto the associated pallet, while minimizing sliding movement of the articles with respect to the pallet and/or the belts of the shuttle conveyor. Operation in this manner is facilitated by the provision of a common drive mechanism 50, preferably comprising a servo drive, for operating the upstream and downstream sections of the shuttle conveyor in concert with each other.

As noted, the downstream section 46 of the shuttle conveyor 38 is mounted for pivotal movement upwardly from the orientation illustrated in FIG. 1, to the upwardly inclined orientation illustrated in FIG. 7. The downstream section 46 of the shuttle conveyor is ordinarily intended to remain in its downwardly-most orientation during operation of the palletizing apparatus 10. However, in the event that the shuttle conveyor apparatus is inadvertently lowered in a fashion which moves downstream section 46 of the shuttle conveyor into contact with articles previously positioned on an associated pallet, the pivotal mounting of the downstream section 46 provides a “flip-up” feature, whereby downstream section 46 of the shuttle conveyor can pivot upwardly, thereby desirably avoiding damage to the shuttle conveyor apparatus, and minimizing any damage of articles previously placed on the associated pallet.

In order to facilitate accurate positioning of articles on the associated pallet, shuttle conveyor apparatus 16 includes a pneumatically-operated arrangement for “squaring” each group or layer of articles after they are positioned on the pallet by transfer from the shuttle conveyor 38. To this end, the shuttle conveyor apparatus 16 includes a laterally extending pusher layer 52 mounted on the vertically adjustable frame 32, by a pair of pneumatically operated cylinders 54. The pneumatic cylinders 54 can be adjusted to operate pusher 52 to exert as much, or as little, force as may be required to provide the desired “squaring” of each group or layer of articles on the associated pallet. Thus, each group of articles can be engaged by the layer pusher, after transfer of the group to the palled, independently of the reciprocation of the shuttle conveyor 38.

As will be appreciated, during vertical movement of adjustable frame 32, to permit each successive group of articles to be stacked one-upon-the-other, the distance between the infeed end of the shuttle conveyor 38, and the discharge end of the conveyor of transfer section 14, will vary slightly. To accommodate this variation, shuttle conveyor apparatus 16 includes an adjustable height conveyor 60 which extends generally between the transfer section 14 and the infeed of shuttle conveyor 38.

The adjustable height conveyor 60 includes a first, infeed end mounted for pivotal movement relative to the conveyor of transfer section 14, and a second, output end mounted for pivotal movement on the vertically adjustable frame 32 of the shuttle conveyor apparatus 16. In the illustrated embodiment, the adjustable height conveyor 60 includes a horizontal frame member 62 which carries a pair of laterally spaced conveyor belts 64.

Notably, the adjustable height conveyor 60 further includes a floor-mounted support frame 66 for pivotally supporting, and bearing the load of, the first end of the adjustable height conveyor independently of the transfer section 14 of the palletizing apparatus. By this arrangement, the support frame 66 is pivotal to accommodate vertical pivotal movement of the adjustable height conveyor attendant to vertical movement of the vertically adjustable frame 32. In the preferred form, the drive mechanism 68 of the adjustable height conveyor 60 is mounted generally adjacent to the floor-mounted support frame 66, and generally beneath the conveying surface of the adjustable height conveyor for pivotal movement with the conveyor relative to the transfer section 14. These features of the adjustable height conveyor desirably act to isolate loads carried by the adjustable height conveyor from the lugging and transfer sections of the apparatus 10, with the illustrated disposition of the drive 68 desirably acting to reduce the load carried by the vertically adjustable shuttle conveyor. Enhanced service life is desirably achieved.

Operation of the present palletizing apparatus will be readily apparent from the foregoing description. Groups or articles to be stacked on a pallet are first assembled at lugging section 12 by initial movement onto rollers 22 in a direction as indicated by the arrows in FIG. 3. After the group of articles, corresponding to one layer of articles to be transferred to the associated pallet, is positioned in the lugging section 12, lugging conveyor 24 is operated in synchronization with the transfer conveyor of transfer section 14 so that the assembled group of articles is moved from the lugging section to the transfer section.

From the transfer section 14, each group of articles is next advanced, by selective intermittent operation of the transfer conveyor, from the transfer section 14 to the adjustable height conveyor 60 of the shuttle conveyor apparatus 16. As the adjustable frame 32 of the shuttle conveyor apparatus 16 is moved vertically for transfer of each group of articles to the associated pallet, adjustable height conveyor 60 moves vertically with the frame of the shuttle conveyor apparatus, with support frame 60 of the adjustable height conveyor pivoting, as necessary, to accommodate the vertical movement of the shuttle conveyor apparatus.

Each group of articles is transferred from the adjustable height conveyor to the shuttle conveyor 38 as the conveyors are operated in synchronization with each other. After each group of articles is received on the shuttle conveyor 38, with the shuttle conveyor at the desired height relative to the associated pallet, the shuttle conveyor is moved from its retracted position to its extended position, wherein the conveyor is positioned in a generally cantilevered orientation with respect to the pallet, with downstream section 46 of the shuttle conveyor positioned generally above the pallet.

Shuttle conveyor 38 is then operated in synchronization with servo drive 41, which effects reciprocable movement of the shuttle conveyor 38 with respect to frame 32. By this synchronized operation of the shuttle conveyor and servo drive 41, each group of articles is transferred from the shuttle conveyor onto the associated pallet, as the shuttle conveyor is moved from its second, extended position back to its first, retracted position.

After each group of articles is stacked onto the pallet, layer pusher 52 can be moved by operation of the associated cylinders 54, whereby the group of articles just placed on the pallet can be “squared” with regard to the pallet and other articles thereon. As noted, this operation of the layer pusher 52 can be effected independently of the reciprocable movement of shuttle conveyor 38.

After placement of each group of articles on the associated pallet, the scissors linkage 34 of the shuttle conveyor apparatus 16 is operated so that shuttle conveyor 38 is positioned for depositing the next group of articles on the pallet. Operation of the apparatus is effected in this fashion for placement of successive groups of articles on the pallet. After the desired number of layers of articles have been placed on the pallet, the loaded pallet is moved out of its operative association with the palletizer, and an empty pallet positioned in its place, with the frame 32 of the shuttle conveyor apparatus 16 lowered so that shuttle conveyor 38 is positioned for placement and stacking of successive groups of articles on the next pallet.

From the foregoing, it will be observed that numerous modifications and variations can be effected without departing from the true spirit and scope of the novel concept of the present invention. It is to be understood that no limitation with respect to the specific embodiment illustrated herein is intended or should be inferred. The disclosure is intended to cover by the appended claims all such modifications as fall within the scope of the claims.

What is claimed is:

1. A palletizing apparatus, comprising:
a lugging conveyor for receiving groups of articles to be palletized;
a transfer conveyor positioned adjacent to and downstream of said lugging conveyor for intermittently receiving said groups of articles from said lugging conveyor; and
a shuttle conveyor apparatus positioned downstream of said transfer conveyor for intermittently receiving said groups of articles therefrom,
said shuttle conveyor apparatus including a vertically adjustable frame, and a shuttle conveyor mounted on said vertically adjustable frame for reciprocable movement with respect thereto between a first, retracted position, and a second, extended position, so that each one of said groups of articles are received on said shuttle conveyor in said first, retracted position thereof, and thereafter moved off of said shuttle conveyor onto an associated pallet after said shuttle conveyor is moved from said first retracted position to said second extended position, and as said shuttle conveyor is moved from said second position back to said first position,
said shuttle conveyor apparatus including a layer pusher mounted on said vertically adjustable frame for engaging and pushing one of said groups of articles after movement onto said pallet from said shuttle conveyor, said layer pusher being movable independently of reciprocable movement of said shuttle conveyor.

2. A palletizing apparatus in accordance with claim 1, wherein:
said shuttle conveyor includes upstream and downstream conveyor sections, with each said group of articles first received on said upstream section from said transfer conveyor, and thereafter conveyed by said downstream section as each said group is moved off of said shuttle conveyor onto said associated pallet.

3. A palletizing apparatus in accordance with claim 2, wherein:
said downstream section of said shuttle conveyor is mounted for pivotal movement relative to said upstream section about a horizontal pivot axis.

4. A palletizing apparatus in accordance with claim 3, wherein:
said shuttle conveyor includes a common drive mechanism or operating said upstream and downstream sections in concert with each other.

5. A palletizing apparatus in accordance with claim 1, wherein:
said vertically adjustable frame of said shuttle conveyor apparatus includes a fluid-actuated scissors linkage.

6. A palletizing apparatus in accordance with claim 1, wherein:
said shuttle conveyor apparatus further includes an adjustable height conveyor extending between said transfer conveyor and said shuttle conveyor, said adjustable height conveyor having a first, infeed end mounted for pivotal movement relative to said transfer conveyor, and a second, output end mounted for pivotal movement on said vertically adjustable frame.

7. A palletizing apparatus in accordance with claim 6, wherein:
said adjustable height conveyor includes a floor-mounted support frame for pivotally supporting and bearing the load of said first end of said adjustable height conveyor independently of said transfer conveyor;
said support frame being pivotal to accommodate vertical pivotal movement of said adjustable height conveyor attendant to vertical movement of said vertically adjustable frame.

8. A palletizing apparatus in accordance with claim 7, wherein:
said adjustable height conveyor includes a drive mechanism mounted generally adjacent to said floor mounted support frame, and generally beneath the conveying surface of said adjustable height conveyor for pivotal movement with said adjustable height conveyor relative to said transfer conveyor.

9. A palletizing apparatus in accordance with claim 1, wherein:
said transfer conveyor includes a servo drive for intermittently receiving said groups of articles and advancing each said group onto said shuttle conveyor apparatus by starting and stopping said servo drive.

10. A palletizing apparatus comprising:
a lugging conveyor for receiving groups of articles to be palletized;
a transfer conveyor positioned adjacent to and downstream of said lugging conveyor for intermittently receiving said groups of articles from said lugging conveyor; and
a shuttle conveyor apparatus positioned downstream of said transfer conveyor for intermittently receiving said groups of articles therefrom,
said shuttle conveyor apparatus including a vertically adjustable frame, and a shuttle conveyor mounted on said vertically adjustable frame for reciprocable movement with respect thereto between a first, retracted position, and a second, extended position, so that each one of said groups of articles are received on said shuttle conveyor in said first, retracted position thereof, and thereafter moved off of said shuttle conveyor onto an associated pallet after said shuttle conveyor is moved from said first retracted position to said second extended position, and as said shuttle conveyor is moved from said second position back to said first position,
said shuttle conveyor including upstream and downstream conveyor sections, with each said group of articles first received on said upstream section from said transfer conveyor, and thereafter conveyed by said downstream section as each said group is moved off of said shuttle conveyor onto said associated pallet,
said downstream section of said shuttle conveyor being mounted for pivotal movement relative to said upstream section about a horizontal pivot axis.

11. A palletizing apparatus in accordance with claim 10, wherein:
said shuttle conveyor includes a common drive mechanism for operating said upstream and downstream sections in concert with each other.

12. A palletizing apparatus in accordance with claim 10, wherein:
said shuttle conveyor apparatus further includes an adjustable height conveyor extending between said transfer conveyor and said shuttle conveyor, said adjustable height conveyor having a first, infeed end mounted for pivotal movement relative to said transfer conveyor, and second, output end mounted for pivotal movement on said vertically adjustable frame.

13. A palletizing apparatus in accordance with claim 12, wherein:
said adjustable height conveyor includes a floor-mounted support frame for pivotally supporting and bearing the load of said first end of said adjustable height conveyor independently of said transfer conveyor; said support frame being pivotal to accommodate vertical pivotal movement of said adjustable height conveyor attendant to vertical movement of said vertically adjustable frame.

14. A palletizing apparatus in accordance with claim 10, including:
a layer pusher mounted on said vertically adjustable frame for engaging and pushing one of said groups of articles after movement onto said pallet from said shuttle conveyor, said layer pusher being movable independently of reciprocable movement of said shuttle conveyor.

15. A palletizing apparatus in accordance with claim 1, wherein:
said transfer conveyor includes a servo drive for intermittently receiving said groups of articles and advancing each said group onto said shuttle conveyor apparatus by starting and stopping said servo drive.

16. A method of palletizing groups of articles, comprising the step of:
successively assembling groups of said articles;
providing a vertically adjustable shuttle conveyor;
intermittently advancing each said group of said articles onto said shuttle conveyor, including vertically adjusting the position of said shuttle conveyor relative to an associated pallet,
reciprocating said shuttle conveyor from a first, retracted position to a second, extended position, and operating said shuttle conveyor to transfer each said group of articles therefrom onto said pallet as said shuttle conveyor is reciprocably moved from said second, extended position back to said first, retracted position, and
engaging each said group of articles with a layer pusher, after transfer to said pallet, independently of the reciprocation of said shuttle conveyor.

17. A method of palletizing in accordance with claim 16, including:
providing said shuttle conveyor with upstream and downstream sections, and
pivotally mounting said downstream section for pivotal movement thereof relative to said upstream section.

18. A method of palletizing in accordance with claim 17, including:
operating said upstream and downstream sections of said shuttle conveyor in concert with each other.

19. A method of palletizing in accordance with claim 16, wherein:
said assembling step includes providing a transfer conveyor on which each said group of articles is assembled,
said advancing step including intermittently starting and stopping said transfer conveyor.

20. A method of palletizing in accordance with claim 19, including:
providing an adjustable height conveyor extending between said transfer conveyor and said shuttle conveyor, said adjustable height conveyor having an infeed end adjacent said transfer conveyor, and an output end adjacent said shuttle conveyor,
said method including providing a floor-mounted support frame for pivotally supporting said first end of said adjustable height conveyor, and pivoting said support frame attendant to vertical movement of said shuttle conveyor.
